(19) United States
(12) Patent Application Publication
(10) Pub. No.: US 2012/0329353 A1
(43) Pub. Date: Dec. 27, 2012

(54) OLEFIN BASED HOT MELT ADHESIVE COMPOSITIONS AND NONWOVEN AND PACKAGING ARTICLES INCLUDING THE SAME

(75) Inventors: Kevin Davis, North Saint Paul, MN (US); Timothy W. Roska, Forest Lake, MN (US); Barry Snyder, Minneapolis, MN (US)

(73) Assignee: H.B. Fuller Company, St. Paul, MN (US)

(21) Appl. No.: 13/169,653

(22) Filed: Jun. 27, 2011

(51) Int. Cl. B32B 5/26; C09J 123/12; B65D 6/28; B32B 27/32; B32B 3/26; B32B 37/12; C09J 153/00; C09J 11/00

(52) U.S. Cl. 442/381; 525/95; 525/240; 524/505; 524/528; 428/523; 428/319.9; 428/316.6; 156/333; 220/612

(57) ABSTRACT

A hot melt adhesive composition that includes a non functionalized metallocene catalyzed polymer and a second polymer selected from the group including amorphous poly alpha olefins, uni-modal metallocene catalyzed polymers, hydrogenated styrenic block copolymers and combinations thereof and nonwoven and packaging articles including the same.

### BACKGROUND

The invention is directed to a hot melt adhesive composition that includes a non functionalized metallocene catalyzed polymer and a second polymer selected from the group including amorphous poly alpha olefins, uni-modal metallocene catalyzed polymers, hydrogenated styrenic block copolymers and combinations thereof.

Hot melt adhesives are often used to bond two substrates together so as to maintain the two substrates in a fixed relation to each other.

In one application, hot melt adhesives are used in articles that include a nonwoven layer to bond the nonwoven layer and a polymer film layer together. It is important that the hot melt adhesive bond the nonwoven layer to the second layer, yet not bleed through the nonwoven layer. Frequently when pressure is applied to such articles, the pressure can force the hot melt adhesive to flow through the nonwoven layer, which is called bleed through. Bleed through of the adhesive can cause unintended and undesirable bonding of the article to another article or substrate.

In another application, hot melt adhesives are used to adhere packaging constructions e.g. bag, box, carton, case and tray together to construct the package, close the package or both. In applications such as these, it is important that the hot melt forms a strong bond that can result in fiber failure when pulled apart at temperatures from about −28.9° C. (−20° F.) to about 65.6° C. (150° F.).

### SUMMARY

In one aspect, the invention features a hot melt adhesive composition that includes from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal; and a second polymer selected from the group consisting of amorphous poly alpha olefin, uni-modal metallocene catalyzed polymer, hydrogenated styrenic block copolymer and combinations thereof.

In one embodiment, the composition further includes from about 5% to about 60% by weight tackifying agent. In another embodiment, the composition further includes a plasticizer.

In some embodiments, the second polymer is an amorphous poly alpha olefin. In other embodiments, the amorphous poly alpha olefin includes at least about 50 weight % polypropylene.

In other embodiments, the composition includes from about 10% by weight to about 40% by weight of the non functionalized metallocene catalyzed polymer; from about 20% by weight to about 60% by weight of the amorphous poly alpha olefin; and from about 5% by weight to about 35% by weight tackifying agent. In some embodiments, the composition has a spiral spray peel of at least 50 grams.

In another aspect, the composition includes an article including a first substrate, a second substrate, and an adhesive composition including from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal, and a second polymer selected from the group consisting of amorphous poly alpha olefin, uni-modal metallocene catalyzed polymer, hydrogenated styrenic block copolymer and combinations thereof, where the first substrate is bonded to the second substrate through the adhesive composition, the composition exhibiting a bleed through value of no greater than about 10 grams.

In one embodiment, the first substrate and second substrate are selected from the group consisting of a porous substrate and a polymer film. In another embodiment, the porous substrate is a nonwoven web. In other embodiments, the article includes a disposable article, filter, diaper, feminine hygiene article, sheet, absorbent pad, animal pad, medical drape, or an adult incontinence article.

In another aspect, the invention features a hot melt adhesive composition that includes from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal; a second polymer selected from the group consisting of amorphous poly alpha olefin, uni-modal metallocene catalyzed polymer, hydrogenated styrenic block copolymer and combinations thereof and a functionalized wax. In one embodiment, the composition further includes a non functionalized wax. In another embodiment, the composition further includes from about 1% by weight to about 15% by weight tackifying agent. It other embodiment, the second polymer is an amorphous poly alpha olefin. In some embodiments, the composition includes at least 55% by weight of the amorphous poly alpha olefin.

In other embodiments, the composition exhibits at least 50% fiber tear at −20° F., and at 150° F. when tested according to the Fiber Tear Test Method.

In another aspect, the invention features a method of making a construction, the method including applying a hot melt adhesive composition including from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal, a second polymer selected from the group consisting of amorphous poly alpha olefin, uni-modal metallocene catalyzed polymer, hydrogenated styrenic block copolymer and combinations thereof; and, a functionalized wax on a surface of a first substrate; and contacting the applied adhesive composition with a second substrate such that the first substrate is bonded to the second drought the adhesive composition, the adhesive composition exhibiting a fiber tearing bond to the first and second substrates.

In one embodiment, at least one of the first and second substrates comprises at least one of paperboard, corrugated paperboard, cardboard, and coated cardboard. In another embodiment a packaging construction is made, the packaging construction being in a form consisting of a bag, box, carton, case and tray.

In some embodiments, the hot melt adhesive exhibits low bleed through and good peel adhesion. In other embodiments, the hot melt adhesive forms a strong bond that can result in fiber failure across a wide temperature range.

Other features and advantages will be apparent from the following description of the preferred embodiments and from the claims.

### DETAILED DESCRIPTION

The hot melt adhesive composition includes a non functionalized metallocene catalyzed polymer comprising at least about 50 weight % of polypropylene where the polymer has an Mw of about 10,000 to about 100,000 and wherein the SEC (Size Exclusion Chromatography) graph of said polymer is multi-modal. The hot melt adhesive composition further includes a second polymer selected from the group consisting of amorphous poly alpha olefins, uni-modal metallocene catalyzed polymers, hydrogenated styrenic block copolymers and combinations thereof.

For purposes of this invention the following terms are defined as set forth below.

By non functionalized it is meant that the polymer has not been contacted with a functional group such as e.g. carboxylic acids, dicarboxylic acids, organic esters, organic anhydrides, organic alcohols, organic acid halides, organic peroxides, amides, and imides.

By functionalized it is meant that the polymer has been contacted with at least one functional group such as e.g. carboxylic acid, dicarboxylic acid, organic ester, organic anhydride, organic alcohol, organic acid halide, organic peroxide, amide, and imide.

By metallocene catalyzed it is meant that the polymer is polymerized by use of one or more metallocene catalysts.

By multi-modal it is meant that the polymer has a multi-modal molecular weight distribution (Mw/Mn) as determined by SEC. This is reflected in the SEC trace having more than one peak or inflection point (i.e. 2 or more inflection points). An inflection point is that point where the second derivative changes in sign (e.g., from negative to positive or vice versa).

By uni-modal it is meant that the polymer has a uni-modal molecular weight distribution (Mw/Mn) as determined by SEC. This is reflected in the SEC trace having only one peak or inflection point.

Molecular weight (i.e. Mw, Mn and Mz) and modality are determined by SEC as described in U.S. Pat. No. 7,294,681 B2 col. 91, line 11 through col. 92, line 64 which is incorporated herein by reference.

### Non Functionalized Metallocene Catalyzed Polymer

The non functionalized metallocene catalyzed polymer includes as least about 50 weight % polypropylene, at least about 60 weight % polypropylene, at least about 70 weight % polypropylene, or even at least about 80 weight % polypropylene.

In some embodiments, the non functionalized metallocene catalyzed polymer comprises from about 2 weight % to about 50 weight %, or from about 2 weight % to about 25 weight % of units derived from at least one C4 to C10 alpha olefin. In other embodiments, the C4 to C10 alpha olefin is hexene-1.

The weight average molecular weight (Mw) of the non functionalized metallocene catalyzed polymer in grams/mole is between about 10,000 to about 100,000, between about 10,000 to about 70,000, or even from about 15,000 to about 60,000.

The viscosity of the non functionalized metallocene catalyzed polymer in centipoise (cps) is no greater than 10,000 cps, no greater than 5,000 cps, no greater than about 1,500 cps, between about 500 and 10,000 cps, or even between about 500 and 2500 when tested at 190° C.

The non functionalized metallocene catalyzed polymer is multi-modal. Multi-modality can be arrived upon in a number of ways. In embodiments, the non functionalized metallocene catalyzed polymer consists essentially of a blend of two or more propylene copolymers. Such blends may be produced by mixing the two or more polymers together, by connecting reactors together in series to make reactor blends, by connecting reactors together in parallel to make reactor blends or by using more than one catalyst in the same reactor to produce multiple species of polymer. The polymers can be mixed together prior to being mixed in the adhesive blend, or may be mixed in the adhesive blending operation.

The non functionalized metallocene catalyzed polymer is present in the hot melt adhesive composition in an amount of from about 5% by weight to about 55% by weight, from about 10% by weight to about 40% by weight, or even from about 15% by weight to about 35% by weight.

One useful non functionalized metallocene catalyzed multi-modal polymer is LINXAR 127 made by ExxonMobil Chemical Company (Houston, Texas).

### Second Polymer

The hot melt adhesive composition further includes a second polymer selected from the group consisting of amorphous poly alpha olefin (APAO), uni-modal metallocene catalyzed polymer, hydrogenated styrenic block copolymer and combinations thereof.

APAO

In some embodiments, the second polymer is an amorphous poly alpha olefin (APAO). APAO is a polymer of one or more alpha olefins (e.g. C2 to C10 olefins). An APAO can be a homopolymer, copolymer or terpolymer. APAO can be manufactured by use of heterogeneous stereospecific polymerization using Ziegler-Natta technology. Such methods are well known in the art and include those methods disclosed in U.S. Pat. No. 4,859,757, U.S. Pat. No. 4,847,340, U.S. Pat. No. 4,736,002 and U.S. Pat. No. 5,714,554.

In some embodiments the APAO is a homopolymer or copolymer of propylene. In some embodiments, the APAO comprises at least about 50% by weight of propylene. In other embodiments, the APAO is a copolymer of at least two of ethylene, propylene and 1-butene.

The APAO can have a viscosity of no greater than about 20,000 cps, no greater than about 15,000 cps, no greater than about 10,000 cps, or no greater than about 5,000, no greater than about 2,500 cps, no greater than about 1,500 cps, or between about 250 cps and about 20,000 cps, or between about 250 cps and about 10,000 cps when tested at 190° C.

The APAO can have an open time of at least about 10 seconds, at least about 20 seconds, at least about 40 seconds or even at least about 60 seconds.

The APAO preferably has a polydispersity index (Mw/Mn) of at least about 4, at least about 5, or even at least about 7.

Useful APAOs are commercially available from a number of sources including REXTAC 2730 and REXTAC 2304 available from REXtac LLC (Odessa, Tex.), EASTOFLEX E1060 available from Eastman Chemical Company (Kingsport, Tenn.) and VESTOPLAST 708 and VESTOPLAST 508 available from Evonik Industries (Marl, Germany).

Uni-Modal Metallocene Catalyzed Polymer

In other embodiments, the second polymer is a uni-modal metallocene catalyzed polymer.

The uni-modal metallocene catalyzed polymer can be linear or substantially linear and can further be homogeneous. The term “homogeneous” as used in reference to the polymer means that the comonomer units when present in the interpolymer are randomly distributed within a given interpolymer molecule and substantially all the interpolymer molecules have the same comonomer ratio within that interpolymer

The uni-modal metallocene catalyzed polymer can be derived from one or more olefin monomers including e.g. C2 to C10 olefins. In one embodiment, the uni-modal metallocene catalyzed polymer includes greater than 50 weight % polypropylene. In another embodiment, the uni-modal metallocene catalyzed polymer is a copolymer of ethylene with at least one additional monomer selected from the group consisting of propylene, butene, hexene and octene.

The uni-modal metallocene catalyzed polymer preferably has a polydispersity index (Mw/Mn) of no greater than 3.5, from 1 to 3.5, from 1.5 to 2.5, or even about 2.0.

Methods of making metallocene catalyzed polymers are well known in the art and include those methods disclosed in U.S. Pat. No. 5,272,236, U.S. Pat. No. 5,278,272, U.S. Pat. No. 4,937,299, and U.S. Pat. No. 5,218,071, and incorporated herein.

Useful uni-modal metallocene catalyzed polymers are commercially available from a number of sources including VISTAMAXX 6202, a propylene ethylene copolymer available from ExxonMobil Chemical Company (Houston, Tex.) and the ENGAGE series of trade designations including e.g. EG 8200, a ethylene octene copolymer available from the Dow Chemical Company (Midland, Mich.).

Styrenic Block Copolymer

In other embodiments, the second polymer is a styrenic block copolymer. Suitable styrenic block copolymers include those having end-blocks of styrene and a rubbery mid-block of butadiene, isoprene, ethylene/propylene, ethylene/butylene and combinations thereof. Styrenic block copolymers are available in a variety of structures including, e.g., A-B-A triblock structures, A-B diblock structures, (A-B), radial block copolymer structures, and branched and functional versions thereof, wherein the A endblock is a non-elastomeric polymer block that includes, e.g., polystyrene, vinyl or a combination thereof, and the B block is an unsaturated conjugated diene or hydrogenated version thereof. Examples of suitable B blocks include isoprene, butadiene, ethylene/butylene (hydrogenated butadiene), ethylene/propylene (hydrogenated isoprene) and combinations thereof. In some embodiments, hydrogenated styrenic block copolymers are preferred.

Useful styrenic block copolymers are commercially available from a number of sources including KRATON G 1657, a styrene ethylene-butene block copolymer available from Kraton Polymers U.S. LLC (Houston, Tex.).

The second polymer is present in the adhesive at, at least about 5 weight %, at least about 10 weight %, at least about 40 weight %, at least about 50 weight %, at least about 55 weight %, at least 55 weight %, at least about 60 weight %, at least about 70 weight %, from about 5 weight % to about 80 weight %, from about 5 weight % to about 20 weight %, from about 5 weight % to about 60 weight %, from about 20 weight % to about 60 weight %, from about 40 weight % to about 80 weight %, or even from about 60 weight % to about 85 weight %.

Tackifying Agent

The compositions can optionally include a tackifying agent. Useful tackifying agents for inclusion in the hot melt adhesive composition include, e.g., natural and modified rosin (e.g., gum rosin, wood rosin, tall-oil rosin, distilled rosin, hydrogenated rosin, dimerized rosin and polymerized rosin), glycerol and pentaerythritol esters of natural and modified rosins (e.g., glycerol ester of pale wood rosin, glycerol ester of hydrogenated rosin, glycerol ester of polymerized rosin, pentaerythritol ester of pale wood rosin, pentaerythritol ester of hydrogenated rosin, pentaerythritol ester of tall oil rosin and the phenolic modified pentaerythritol ester of rosin), polyterpene resins having a softening point, as determined by ASTM method E28-58T, of from about 10° C. to 140° C. and hydrogenated polyterpene resins, copolymers and terpolymers of natural terpenes (e.g. styrene-terpene, alpha-methyl styrene-terpene and vinyl toluene-terpene), aliphatic and cycloaliphatic petroleum hydrocarbon resins having Ring and Ball softening points of from about 10° C. to 140° C. (e.g., branched and unbranched C₅ resins, C₉ resins, and C₁₀ resins), aromatic petroleum hydrocarbons and the hydrogenated derivatives thereof, aliphatic/aromatic petroleum derived hydrocarbons and the hydrogenated derivatives thereof, and combinations thereof.

A number of useful tackifying agents are commercially available from a variety of sources including, e.g., ESCOREZ 5400 and ESCOREZ 5415 dicyclopentadiene from ExxonMobil Chemical Company (Houston, Tex.), and EASTOTAC H130W aliphatic hydrocarbon resin and EASTOTAC H-100L hydrogenated C₅ aliphatic hydrocarbon tackifying resin, both of which are available from Eastman Chemical Company (Kingsport, Tenn.). The tackifying agent can be present in the hot melt adhesive composition in an amount of from about 5% by weight to about 60 weight %, from about 5% by weight to about 40% by weight, from about 5% to about 30% by weight, from about 1% by weight to about 15% by weight, less than about 30% by weight, less than about 20% by weight, less than about 10% by weight, less than about 8% by weight, or even less than about 5% by weight.

### Plasticizer

The compositions can optionally include a plasticizer. Suitable classes of plasticizers for inclusion in the hot melt composition include, e.g., liquid plasticizers. Suitable plasticizers include, e.g., plasticizing oils (e.g., mineral oil and naphthenic oil), olefin oligomers, and low molecular weight polymers, cycloparaffin oils, animal oil and derivatives of such oils. Examples of useful olefin oligomers include propylene, polybutene, and hydrogenated polyisoprene. Suitable animal oils include glycerol esters of the fatty acids and polymerization products thereof. One example of a useful commercially available mineral oil is KRYSTOL 550 from Petrochem Carless Limited (Surrey, England). The plasticizer can be present in the hot melt adhesive composition in an amount of from about 5% by weight to about 35% by weight, from about 20% by weight to about 35% by weight, or even from about 20% by weight to about 30% by weight.

### Wax

The composition can optionally include wax. Useful classes of waxes include, e.g., paraffin waxes, microcrystalline waxes, high density low molecular weight polyethylene waxes, by-product polyethylene waxes, Fischer-Tropsch waxes, oxidized Fischer-Tropsch waxes, functionalized waxes e.g. (acid, anhydride, and hydroxy modified polyethylene waxes), animal waxes, vegetable waxes and combinations thereof. Useful waxes are solid at room temperature and preferably have a Ring and Ball softening point of from 50° C. to 120° C. Useful low molecular weight polyethylene waxes include (i.e., polyethylene having a molecular weight (Mw) from 500 to 10,000) and an ASTM softening point of from about 65° C. to about 125° C. Useful paraffin waxes have a melting point of from about 50° C. to about 80° C. Useful microcrystalline waxes have a melting point of from about 55° C. to 95° C. as determined by ASTM method D127-60. One useful wax is a maleated polypropylene wax. Examples of useful commercially available waxes include BARECO PX100, a Fischer-Tropsch wax from Baker Hughes Inc. (Sugar Land, Tex.) and AC596, a maleated polypropylene wax from Honeywell International Incorporated (Morristown, N.J.). Wax is preferably present in the hot melt adhesive composition in an amount of from 0% by weight to about 30% by weight, from about 5% by weight to about 25% by weight, from about 5% by weight to about 20% by weight, less than about 5% by weight, less than about 10% by weight or even less than about 15% by weight.

### Other Components

The hot melt adhesive composition optionally includes other components including, e.g., other polymers (e.g., high density polyethylene, linear low density polyethylene, non-metallocene catalyzed linear low density polyethylene, metallocene catalyzed polyolefins, block copolymers (e.g., styrene-ethylene-butadiene-styrene block copolymer), and combinations thereof, stabilizers, antioxidants, pigments, dyes, ultraviolet light absorbers, flame retardants, fillers, and combinations thereof. Useful antioxidants include high molecular weight hindered phenols and multifunctional phenols. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and the trade designation 1RGAFOS 168 phosphite antioxidant all of which are available from BASF (Florham Park, N.J.), the BNX series of trade designations, including, e.g., BXN 1010 from Mayzo, Inc. (Norcross, Ga.), the CYANOX LTDP trade designation from Cytec Industries (Stamford, Conn.), the ETHANOX 330 trade designation from Albemarle Corp. (Baton Rouge, La.) and the EVERNOX 76 trade designation from Everspring Corporation (Santa Monica, Calif.). The hot melt adhesive composition includes from about 0% by weight to about 2.0% by weight or even from about 0.1% to about 1.0% by weight antioxidant.

Useful stabilizers include phosphites, such as tris-(p-nonylphenyl)-phosphite (TNPP) and bis(2,4-di-tert-butylphenyl)4,4′-diphenylene-diphosphonite and di-stearyl-3,3′-thiodipropionate (DSTDP).

### Disposables

The adhesives of this invention can be useful in bonding a first substrate to a second substrate e.g. as in the lamination of porous substrates and polymer film such as those used in the manufacture of disposable articles including, e.g., medical drapes, medical gowns, sheets, feminine hygiene articles, diapers, adult incontinence articles, absorbent pads (e.g., for animal pads (e.g., pet pads) and humans (e.g., bodies and corpses)) and on a variety of substrates including, e.g., porous substrates (e.g., nonwoven webs and perforated films), film (e.g., polymer films (e.g., polyethylene, polypropylene, polyvinylidene chloride, ethylene vinyl acetate, and polyester films).

The adhesive composition is also suitable for a variety of constructions including, e.g., multi-layer constructions including, e.g., laminates (e.g., layers of polymer film, porous substrate (e.g., nonwoven web and perforated film) and combinations thereof). The multiple layers can have the same or different composition. Useful laminates include a porous substrate bonded to a second substrate through an adhesive composition disclosed herein. In some embodiments, the first substrate is a nonwoven web and the second substrate is a nonwoven web, a polymer film or a combination thereof.

The hot melt adhesive composition, when in contact with a porous substrate and subjected to heat and pressure, preferably resists migration through the porous substrate. One measure of the degree of adhesive migration through a porous substrate under pressure is bleed through. The hot melt adhesive composition exhibits a bleed through value of no greater than about 30 grams, no greater than about 20 grams, no greater than about 10 grams, or even no greater than about 5 grams.

The hot melt adhesive composition exhibits an initial T-Peel value of at least about 50 grams, at least about 70 grams, at least about 80 grams, or even at least about 90 grams when tested at 23° C. and 50% humidity. After storage for four weeks at 50° C. and 50% relative humidity, the hot melt adhesive composition exhibits a T-Peel value of at least about 50 grams, at least about 60 grams, or even at least about 70 grains when tested at 23° C. and 50% humidity.

The hot melt adhesive composition exhibits a viscosity of no greater than about 10,000 centipoise (cp), no greater than about 7000 cp, or even no greater than about 5000 cp at about 149° C. (300° F.).

### Packaging

The adhesives of this invention can be useful in a method of making a construction including e.g. a packaging construction, to assemble the construction, close the construction or both. A method of making a construction can include applying the hot melt adhesive on a surface of a first substrate, contacting the hot melt adhesive with the second substrate, such that the first substrate is bonded to the second through the adhesive composition and the adhesive composition exhibits a fiber tearing bond to the first and second substrate. Possible packaging constructions include e.g. bag, box, carton and case. Possible substrates include, polymer films, metalized polymer films, paperboard, cardboard, coated cardboard, fiber board, virgin and recycled kraft, high and low density kraft, chipboard various types of treated and coated kraft and chipboard, and corrugated versions of the same, clay coated chipboard carton stock, composites and combinations thereof.

Useful composites include, e.g., chipboard laminated to metal foil (e.g., aluminum foil), which is optionally laminated to one or more layers of polymer film. Alternatively or in addition, the film is optionally bonded directly to chipboard, kraft and combinations thereof.

In a preferred embodiment, the hot melt adhesive composition includes non-functionalized metallocene catalyzed polymer, a second polymer consisting of an APAO, a functionalized wax and a non functionalized wax.

The adhesive composition can exhibit fiber failure when tested at −28.9° C. (−20° F.) of no less than about 40%, no less than about 50%, or even no less than about 60%.

The adhesive composition can exhibit fiber failure when tested at 4.4° C. (40° F.) of no less than about 40%, no less than about 50%, or even no less than about 60%.

The adhesive composition can exhibit fiber failure when tested at 48.9° C. (120° F.) of no less than about 40%, no less than about 50%, or even no less than about 60%.

The adhesive composition can exhibit fiber failure when tested at 65.6° C. (150° F.) of no less than about 40%, no less than about 50%, or even no less than about 60%.

The adhesive composition can have a viscosity of no greater than about 2,000 cps, no greater than about 1,500 cps, or even no greater than about 1,300 cps when tested and 176.7° C. (350° F.).

### Manufacturing and Application

Useful methods of making the hot melt adhesive composition include, e.g., continuous processes and batch processes.

The adhesive can be applied to a substrate in any useful form including, e.g., as a continuous coating, a discontinuous coating, in a pattern, randomly, and combinations thereof, using any suitable application method including, e.g., slot coating, spray coating (e.g., spiral spray and random fiberization (e.g., melt blowing)), extrusion (e.g., applying a bead, and fine line extrusion), wheel application, noncontact coating, contacting coating, gravure, roll coating, transfer coating, and combinations thereof.

The adhesive compositions of this invention may also be useful in book binding, foam bonding, heat sealing applications, carpet sealing, bag end sealing, bonding filter media, insulation bonding, durable goods manufacturing (e.g., shoes and other athletic gear), wood working, construction, automotive applications, appliance applications, assembly applications (e.g., filter media, insulation, and bonding).

The invention will now be described by way of the following examples.

### EXAMPLES

### Test Procedures

Test procedures used in the examples include the following. All ratios and percentages are by weight unless otherwise indicated.

### Viscosity

Viscosity is determined in accordance with ASTM D-3236 entitled, “Standard Test Method for Apparent Viscosity of Not Melt Adhesives and Coating Materials,” (Oct. 31, 1988). Melt viscosities are determined on a Brookfield Thermosel Viscometer Model LVDV 2+using an appropriate spindle, and reported in centipoise (“cps”).

### Fiber Tear Test Method

Fiber tear measures the percentage of fiber that covers the area of the adhesive after two substrates, which have been previously bonded together through the adhesive, are separated by force. The percentage of fiber tear is determined as follows. A bead of adhesive composition measuring 15.24 cm (6 inch)×0.24 cm ( 3/32 inch) is applied to a first substrate of Inland high performance 57 pound 100% virgin liner board, using a Waldorf bond simulator at the specified application temperature. Two seconds after the bead of adhesive is applied to the first substrate, the bead of adhesive is contacted with a second substrate of Inland high performance 57 pound 100% virgin liner board, which is pressed against the adhesive and the first substrate with a pressure of 0.21 Mpa (30 pounds per square inch (psi)) for a period of 2 seconds. The resulting construction is then conditioned at the specified test temperature for at least 24 hours, and then the substrates of the construction are separated from one another by pulling the two substrates apart from one another by hand. The surface of the adhesive composition is observed and the percent of the surface area of the adhesive composition that is covered by fibers is determined and recorded. A minimum of five samples are prepared and tested for each hot melt adhesive composition.

### Test Sample Preparation

A multi-bead applicator and laminator are set to a temperature of 300° F., a nip pressure of 15 psi, an application weight of 1.4 mg/in (milligrams per inch), and minimal rewind and unwind tensions so as not to stretch film. A 1 mil thick white embossed polyethylene film that includes a blend of linear low density polyethylene and low density polyethylene (e.g., DH-284 PE MICROFLEX Embossed Non-Breathable film having an emboss gauge of 1.8 mils (ASTM D374), 70 gram F50 impact strength (ASTM D1709), 670% elongation at break in the machine direction (ASTM D882), 920% elongation at break in the cross direction (ASTM D882), 590 grams tensile at 10% elongation in the machine direction (ASTM D882), 550 grams tensile at 10% elongation in the cross direction (ASTM D882), 2500 ultimate tensile in the machine direction (ASTM D882), and 1700 grams ultimate tensile in the cross direction (ASTM D882) available from Clopay Plastic Products Company, Inc., (Cincinnati, Ohio) or equivalent thereof), which has been corona treated on one side thereof to surface energy of 38 dynes per square centimeter (dynes/cm²) (as measured using dynes pens), is passed through the applicator. A bead of adhesive is applied to the corona treated side of the polymer film and then the film and adhesive are nipped to a 15 grams/square meter (g/m²) basis weight spunbond polypropylene nonwoven web having a 7 mil Thwing-Albert thickness (e.g., UNIPRO 45 nonwoven web from Midwest Filtration Company) to form a laminate.

The speed at which the film passes through the applicator is from 400 feet per minute (ft/min) to 900 ft/min and the adhesive coat weight is 1.4 mg/in. A sufficient amount of laminate is prepared such that 60 inches of representative lamination can be collected for testing.

### Bleed Through Test Method

From seven to ten test samples are cut from the laminate prepared according to the Test Sample Preparation immediately after the laminate is prepared. The test samples are cut to a length of seven inches in the machine direction and one inch in the cross-machine direction while ensuring that the bead of hot melt composition is centered in the cross-machine direction of the test sample. These samples form the test strips.

Additionally, from 7 to 10 blank strips are cut from the same roll of corona-treated polymer film that is used to prepare the test strips. The blank strips of polymer film are cut to a length of seven inches in the machine direction and one inch in the cross-machine direction being careful to note which side is the corona treated side of the polymer film.

A 3500 g weight and two glass plates (5 inch long by 4 inch wide) are preconditioned in an oven at 120° F. and 50% relative humidity for at least one hour before starting the test. A 1 in. by 7 in. blank strip of the corona treated polymer film is placed on one of the glass plates with the corona-treated side of the film facing up (i.e., the treated side is not in contact with the glass plate). A 1 in. by 7 in. test strip is then placed on the blank strip of polymer film such that the polymer film side of the test strip is facing up and the nonwoven side of the test strip is facing down (i.e., in contact with the blank strip of corona-treated polymer film). A second blank strip of polymer film is then placed on top of the first test strip such that the untreated side of the second blank strip of polymer film contacts the treated side of the polymer film of the first test strip. Then, a second test strip is placed on top of the second blank strip of polymer film with the polymer film side of the test strip facing up. This procedure is repeated until all of the test strips have been added to the stack.

A second glass plate is then placed on top of the stack of alternating polymer film layers and test strips. The heated 3500 g weight is placed on the second glass plate such that the samples are pressed between the two glass plates. The stack is then placed in the 120° F. oven at 50% relative humidity for one hour. The stack is then removed after one hour and allowed to cool at room temp (about 21° C.) at 50% relative humidity for 15 minutes.

Each test sample, which includes the test strip and neighboring corona-treated polymer film, is then removed from the stack and tested according to a T-peel test method. The test strip of the test sample is placed in stationary grip of the tester and the blank corona-treated polymer film is placed in the moving grip of the tester. The corona-treated polymer film is peeled back from the test strip at a rate of 12 inches per minute (in/min) over a ten second peel time. The peak peel value is obtained and recorded for each test sample.

This test is repeated for each of the test samples (i.e., each pair of blank polymer film and test strip). The average of the peak values and the standard deviation of the peak peel values for the seven to ten test samples are reported in grams.

### T-Peel Test Method

The T-Peel test is used to measure the bond strength of an adhesive coated between two flexible substrates. T-Peel is determined using ASTM D1876-01 entitled, “Test Method for Determining Peel Resistance of Adhesive (T-Peel Test Method),” with the exception that it is run at 12 inches per minute, instead of 10 in per minute, over a period of 10 seconds, and 7 replicates are run instead of the 10 specified in ASTM D1876. The samples are run on an INSTRON type test instrument. The test samples are prepared as described in the Test Sample Preparation with the exception that the adhesive is coated in a spiral spray pattern with a coat weight of 4.0 mg/in². The average peel value over 10 seconds of peeling is recorded, and the results are reported in grains. The initial T-Peel value is the value measured 24 hours after the laminate is prepared. The four week T-Peel value is measured after the sample is subjected to accelerated aging at 50° C. and 50% relative humidity for four weeks.

### Preparation of Examples in Table 1

Control 1 is D3166 commercially available from H.B. Fuller (St. Paul, Minn.).

Control 2 was made in a sigma blade mixer equipped with oil heat. The heat was set to 176.7° C. (350° F.) LINXAR 127 was added first and allowed to mix for around 30 minutes. The ESCOREZ 5400 was added next and the blend allowed to mix for around 30 more minutes until smooth and homogeneous.

Example 1 and Example 2 were made in a similar manner to Control 2, with the following additions. The REXTAC 2730/VISTAMAXX 6202 and the antioxidants were added to the mixer up front with the LINXAR 127. After the ESCOREZ 5400 was added and allowed to mix, the KRYSTOL 550 was added slowly in portions. Once the KRYSTOL 550 was completely in, the adhesive was allowed to mix for around 30 minutes more until smooth and homogeneous.

Controls 1-2 and Examples 1-2 were tested according to the viscosity, bleed through, and T-Peel test methods. The results are set forth below in Table 1.

### Materials

LINXAR 127—multi-modal propylene hexene copolymer having a viscosity at 190° C. of 825 cps, a density of 0.86 g/cm and a peak melting temperature of 125° C.

ESCOREZ 5400—dicyclopentadiene tackifying agent having a 100° C. melting point

KRYSTOL 550—saturated white mineral oil

REXTAC2730—polypropylene butene-1 copolymer with a viscosity of about 3000 at 190° C.

REXTAC2304—polypropylene ethylene copolymer with a viscosity of about 450 cps at 190° C.

VISTAMAX 6202—propylene ethylene copolymer with an MFR (230° C./2.16 kg) of 18 g/10 min

EPOLENE N-21—polyethylene wax

AC-596—maleated polypropylene wax

EVERNOX 76—hindered phenol antioxidant

IRGANOX 1010—hindered phenol antioxidant

TABLE 1

| | Control 1 | | | |
|---|---|---|---|---|
| Sample | D3166 | Control 2 | Example 1 | Example 2 |
| LINXAR 127 | | 75 | 29 | 44 |
| ESCOREZ 5400 | | 25 | 10 | 24.8 |
| KRYSTOL 550 | | | 15 | 20 |
| REXTAC 2730 | | | 44.8 | |
| VISTAMAX | | | | 10 |
| 6202 | | | | |
| COEXTRUSION | | | 1 | 1 |
| COATING | | | | |
| EVERNOX 76 | | | 0.2 | 0.2 |
| Viscosity at | 4800 | 1625 | 1845 | 3265 |
| 300° F. (148.9° C.) | | | | |
| (cps) | | | | |
| Viscosity at | 14350 | 16900 | 10950 | 17050 |
| 250° F. (121.1° C.) | | | | |
| (cps) | | | | |
| Molten Gardner | 2 | 1 | 3 | 2 |
| Color | | | | |
| Bleed Through | 32 | 0 | 0 | 0 |
| (g) | | | | |
| Average Initial | 117 | 5 | 99 | 84 |
| T-Peel (g) | | | | |
| Average 4 Week | 163 | Not | 106 | 61 |
| T-Peel (g) | | Tested | | |
| | | (NT) | | |

### Example 3

71.5 weight % of REXTAC 2304, 15 weight % of LINXAR 127, 10 weight % EPOLENE N-21, 2 weight % AC596 and 1.5 weight % IRGANOX 1010 is heated in a metal can in an oven set to 176.7° C. (350° F.) for about an hour. The can is removed from the oven and placed in a heating mantle (e.g. Glas-Col, Terre Haute, Ind.) which maintains the temperature of the composition at around 176.7° C. The composition is mixed with an upright Stirrer Type RZRI mixer (e.g. Caframo, Wiarton, Ontario, Canada.) equipped with a propeller blade until smooth. The final adhesive will have a viscosity of less than about 1000 cps at 176.7° C. (350° F.) and fiber failure of at least about 50% when tested at temperatures of −28.9° C. (−20° F.) and 65.6° C. (150° F.).

Other embodiments are within the claims. All patents and references referred to herein are incorporated herein in their entirety to the extent they do not conflict.

What is claimed is:

1. An adhesive composition comprising:
from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal; and
a second polymer selected from the group consisting of amorphous poly alpha olefin, uni-modal metallocene catalyzed polymer, hydrogenated styrenic block copolymer and combinations thereof.

2. The composition of claim 1 further comprising from about 5% to about 60% by weight tackifying agent.

3. The composition of claim 2 further comprising a plasticizer.

4. The composition of claim 2 wherein the second polymer is an amorphous poly alpha olefin.

5. The composition of claim 4 wherein the amorphous poly alpha olefin comprises at least about 50 weight % polypropylene.

6. The composition of claim 1 comprising:
from about 10% by weight to about 40% by weight of the non functionalized metallocene catalyzed polymer;
from about 20% by weight to about 60% by weight of the amorphous poly alpha olefin; and
from about 5% by weight to about 35% by weight tackifying agent.

7. The adhesive composition of claim 1 wherein the composition has a spiral spray peel of at least 50 grams.

8. An article comprising:
a first substrate;
a second substrate; and
an adhesive composition comprising:
from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal; and
a second polymer selected from the group consisting of amorphous poly alpha olefin, uni-modal metallocene catalyzed polymer, hydrogenated styrenic block copolymer and combinations thereof.
where the first substrate is bonded to the second substrate through the adhesive composition, the composition exhibiting a bleed through value of no greater than about 10 grams.

9. The article of claim 8, wherein the first substrate and second substrate are selected from the group consisting of a porous substrate and a polymer film.

10. The article of claim 9, wherein the porous substrate is a nonwoven web.

11. The article of claim 8, wherein the article comprises a disposable article, filter, diaper, feminine hygiene article, sheet, absorbent pad, animal pad, medical drape, or an adult incontinence article.

12. The composition of claim 1 further comprising a functionalized wax.

13. The composition of claim 12 further comprising a non functionalized wax.

14. The composition of claim 12 further comprising from about 1% by weight to about 15% by weight tackifying agent.

15. The composition of claim 12 wherein the second polymer is an amorphous poly alpha olefin.

16. The composition of claim 15 comprising at least 55% by weight of the amorphous poly alpha olefin.

17. The adhesive composition of claim 12, wherein the composition exhibits at least 50% fiber tear at −20° F., and at 150° F. when tested according to the Fiber Tear Test Method.

18. A method of making a construction, the method comprising:
applying a hot melt adhesive composition comprising:
from about 5% by weight to about 55% by weight of a non functionalized metallocene catalyzed polymer comprising at least 50 weight % of polypropylene, the polymer having an Mw of about 10,000 to about 100,000 and an SEC graph that is multi-modal;
a second polymer selected from the group consisting of amorphous poly alpha olefin, uni-modal metallocene catalyzed polymer, hydrogenated styrenic block copolymer and combinations thereof; and,
a functionalized wax
on a surface of a first substrate; and
contacting the applied adhesive composition with a second substrate such that the first substrate is bonded to the second throught the adhesive composition, the adhesive composition exhibiting a fiber tearing bond to the first and second substrates.

19. The method of claim 18, wherein at least one of the first and second substrates comprises at least one of paperboard, corrugated paperboard, cardboard, and coated cardboard.

20. A packaging construction made by the method of claim 18, the packaging construction being in a form selected from the group consisting of bag, box, carton, case and tray.
